(19) United States
(12) Patent Application Publication
(10) Pub. No.: US 2026/0307792 A1
(43) Pub. Date: Oct. 8, 2026

(54) MULTILINGUAL IN-FLIGHT PLANNING SYSTEM FOR PERSONALIZED PASSENGER EXPERIENCE

(71) Applicant: B/E Aerospace, Inc., Winston-Salem, NC (US)

(72) Inventors: Soumalya Sarkar, Glastonbury, CT (US); Andrew Radlbeck, South Glastonbury, CT (US); Brian E. St. Rock, Andover, CT (US)

(73) Assignee: B/E Aerospace, Inc., Winston-Salem, NC (US)

(21) Appl. No.: 19/633,706

(22) Filed: Mar. 30, 2026

Related U.S. Application Data
(60) Provisional application No. 63/785,389, filed on Apr. 8, 2025.

(51) Int. Cl. B64D 11/00; B64D 11/04; G10L 15/00; G10L 15/22

(52) U.S. Cl. CPC B64D 11/0015; G10L 15/22; B64D 11/04; G10L 15/005

(57) ABSTRACT

A multilingual in-flight planning system for aircraft interiors including a first user interface configured to receive and transmit first information to or from a passenger in a native language of the passenger, a second user interface configured to receive and transmit second information to or from at least one crew member; and a multilingual language-enabled virtual assistant. The multilingual language-enabled virtual assistant is communicatively coupled to the first user interface and the second user interface and configured to: receive a request from at least one of the first user interface or the second user interface; analyze the request based on at least one of context or intent; and generate a response to the request, wherein the response is transmitted to either a user interface of the at least one of the first user interface or the second user interface that generated the request or an opposite one.

### CROSS-REFERENCE TO RELATED APPLICATIONS

This application claims priority to and the benefit of, U.S. Provisional Application No. 63/785,389, filed Apr. 8, 2025, and entitled “MULTILINGUAL IN-FLIGHT PLANNER FOR PERSONALIZED PASSENGER EXPERIENCE,” which is incorporated by reference herein in its entirety for all purposes.

### FIELD

The present disclosure generally relates to aircraft interiors, and more specifically, to a multilingual in-flight planning system for personalized passenger experience.

### BACKGROUND

Typically, providing personalized and on-time care to every passenger within an aircraft with limited crew is challenging. From a passenger's perspective, a long flight may become quite monotonous and delay, even if small, in crew response or the lack of preferred in-flight treatment may make the experience tiresome for a passenger.

### SUMMARY

A multilingual in-flight planning system for aircraft interiors is disclosed herein. The system includes a first user interface configured to receive and transmit first information to or from a passenger in a native language of the passenger, a second user interface configured to receive and transmit second information to or from at least one crew member, and a multilingual language-enabled virtual assistant. The multilingual language-enabled virtual assistant is communicatively coupled to the first user interface and the second user interface. The multilingual language-enabled virtual assistant is configured to: receive a request from at least one of the first user interface or the second user interface; analyze the request based on at least one of context or intent; and generate a response to the request. The response is transmitted to either a user interface of the at least one of the first user interface or the second user interface that generated the request or an opposite one of the at least one of the first user interface or the second user interface that generated the request.

In various embodiments, responsive to receiving the request from the passenger via the first user interface, the multilingual language-enabled virtual assistant is further configured to: reference a passenger conversation memory to determine whether a previous request has been received from the passenger; and, responsive to identifying the previous request from the passenger, query the passenger for at least one of a verification or a clarification of the request with the passenger via the first user interface. In various embodiments, the at least one of the verification or the clarification of the request is presented to the passenger via text to speech via the first user interface or displayed in a display of the first user interface.

In various embodiments, responsive to verifying or clarifying the request with the passenger via the first user interface, the multilingual language-enabled virtual assistant is further configured to: transmit the request to the at least one crew member associated with the second user interface. In various embodiments, the request is presented to the at least one crew member via text to speech via the second user interface or displayed in a display of the second user interface.

In various embodiments, responsive to transmitting the request to the at least one crew member associated with the second user interface, the multilingual language-enabled virtual assistant is further configured to: send a notification to the passenger, via the first user interface, that the request has been forwarded to the at least one crew member.

In various embodiments, responsive to receiving the request from the passenger via the first user interface, the multilingual language-enabled virtual assistant is further configured to: reference a galley/interior state/item database to determine whether an item associated with the request is available; and, responsive to identifying the item associated with the request being unavailable, send a first notification to the passenger, via the first user interface that the item associated with the request is unavailable. In various embodiments, the first notification is presented to the passenger via text to speech via the first user interface or displayed in a display of the first user interface.

In various embodiments, responsive to identifying the item associated with the request is available, the multilingual language-enabled virtual assistant is further configured to: transmit the request to the at least one crew member associated with the second user interface. In various embodiments, the request is presented to the at least one crew member via text to speech via the second user interface or displayed in a display of the second user interface.

In various embodiments, responsive to transmitting the request to the at least one crew member associated with the second user interface, the multilingual language-enabled virtual assistant is further configured to: send a second notification to the passenger, via the first user interface, that the request has been forwarded to the at least one crew member.

In various embodiments, the first user interface is configured to receive the request from the passenger via automatic speech recognition (ASR) configured to interpret the information received via the first user interface and generate a set of interpreted words in text form, the set of interpreted words in text form utilized to generate the request.

In various embodiments, the first user interface is an infotainment system associated with a passenger seat of an aircraft.

In various embodiments, the second user interface is a digital panel associated with a galley on an aircraft.

Also disclosed herein is an aircraft including a passenger seat, an infotainment system associated with the passenger seat, a galley, a digital panel associated with the galley, and a multilingual in-flight planning system coupled to at least one infotainment system or the digital panel. The multilingual in-flight planning system includes a first user interface configured to receive and transmit first information to or from a passenger in a native language of the passenger, a second user interface configured to receive and transmit second information to or from at least one crew member, and a multilingual language-enabled virtual assistant. The multilingual language-enabled virtual assistant is communicatively coupled to the first user interface and the second user interface. The multilingual language-enabled virtual assistant is configured to: receive a request from at least one of the first user interface or the second user interface; analyze the request based on at least one of context or intent; and generate a response to the request. The response is transmitted to either a user interface of the at least one of the first user interface or the second user interface that generated the request or an opposite one of the at least one of the first user interface or the second user interface that generated the request.

In various embodiments, responsive to receiving the request from the passenger via the first user interface, the multilingual language-enabled virtual assistant is further configured to: reference a passenger conversation memory to determine whether a previous request has been received from the passenger; and, responsive to identifying the previous request from the passenger, query the passenger for at least one of a verification or a clarification of the request with the passenger via the first user interface. In various embodiments, the at least one of the verification or the clarification of the request is presented to the passenger via text to speech via the first user interface or displayed in a display of the first user interface.

In various embodiments, responsive to verifying or clarifying the request with the passenger via the first user interface, the multilingual language-enabled virtual assistant is further configured to: transmit the request to the at least one crew member associated with the second user interface. In various embodiments, the request is presented to the at least one crew member via text to speech via the second user interface or displayed in a display of the second user interface.

In various embodiments, responsive to transmitting the request to the at least one crew member associated with the second user interface, the multilingual language-enabled virtual assistant is further configured to: send a notification to the passenger, via the first user interface, that the request has been forwarded to the at least one crew member.

In various embodiments, responsive to receiving the request from the passenger via the first user interface, the multilingual language-enabled virtual assistant is further configured to: reference a galley/interior state/item database to determine whether an item associated with the request is available; and, responsive to identifying the item associated with the request being unavailable, send a first notification to the passenger, via the first user interface that the item associated with the request is unavailable. In various embodiments, the first notification is presented to the passenger via text to speech via the first user interface or displayed in a display of the first user interface.

In various embodiments, responsive to identifying the item associated with the request is available, the multilingual language-enabled virtual assistant is further configured to: transmit the request to the at least one crew member associated with the second user interface. In various embodiments, the request is presented to the at least one crew member via text to speech via the second user interface or displayed in a display of the second user interface.

In various embodiments, responsive to transmitting the request to the at least one crew member associated with the second user interface, the multilingual language-enabled virtual assistant is further configured to: send a second notification to the passenger, via the first user interface, that the request has been forwarded to the at least one crew member.

In various embodiments, the first user interface is configured to receive the request from the passenger via automatic speech recognition (ASR) configured to interpret the information received via the first user interface and generate a set of interpreted words in text form, the set of interpreted words in text form utilized to generate the request.

In various embodiments, the first user interface is the infotainment system associated with the passenger seat of the aircraft.

In various embodiments, the second user interface is the digital panel located in the galley on the aircraft.

The present disclosure may include any one or more of the individual features disclosed above and/or below alone or in any combination thereof. The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates an aircraft and various sections within the aircraft, in accordance with various embodiments.

FIG. 2 illustrates a layout of a typical larger-bodied passenger aircraft, in accordance with various embodiments.

FIG. 3 illustrates a multilingual in-flight planning system for personalized passenger experience, in accordance with various embodiments.

FIG. 4 illustrates a flow diagram of a multilingual in-flight planning system for personalized passenger experience receiving a drink request from a passenger, in accordance with various embodiments.

FIG. 5 illustrates a flow diagram of a multilingual in-flight planning system for personalized passenger experience receiving a blanket request from a passenger, in accordance with various embodiments

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an,” or “the” may include one or more than one and that reference to an item in the singular may also include the item in the plural. Further, all ranges may include upper and lower values and all ranges and ratio limits disclosed herein may be combined.

As stated previously, typically, providing personalized and on-time care to every passenger within an aircraft with limited crew members is challenging. From a passenger's perspective, a long flight may become quite monotonous and any bit of delay in crew member response or the lack of preferred in-flight treatment may make the in-flight experience tiresome for the passenger. Accordingly, there is a growing need to supplement reduced crew operations with smart virtual assistants that interact in a natural language of the passenger as well as the crew members in order to plan and provide personalized in-flight experiences for passengers.

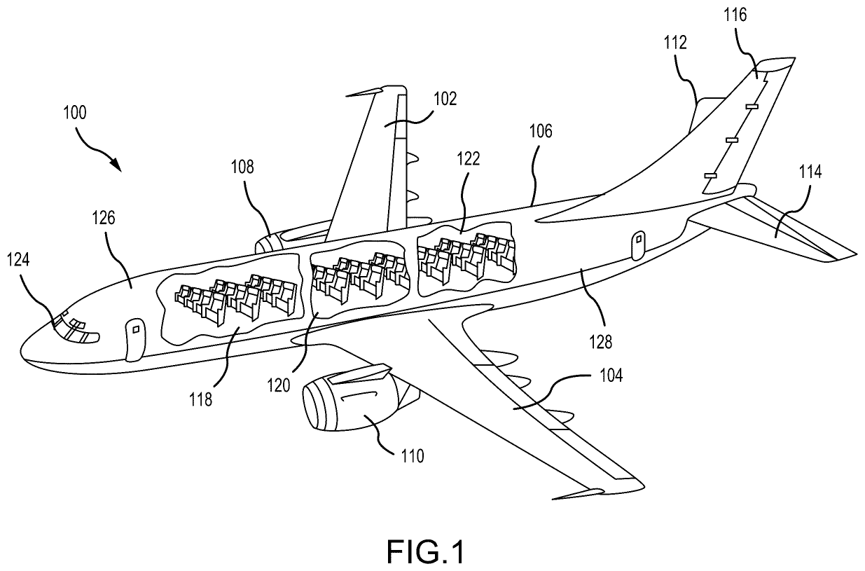

Referring now to FIG. 1, an aircraft 100 and various sections within the aircraft is illustrated, in accordance with various embodiments. Aircraft 100 is an example of a passenger or transport vehicle in which a multilingual in-flight planning system may be implemented in accordance with various embodiments. In various embodiments, aircraft 100 has a starboard wing 102 and a port wing 104 attached to a fuselage 106. In various embodiments, aircraft 100 also includes a starboard engine 108 connected to starboard wing 102 and a port engine 110 connected to port wing 104. In various embodiments, aircraft 100 also includes a starboard horizontal stabilizer 112, a port horizontal stabilizer 114, and a vertical stabilizer 116. In various embodiments, aircraft 100 also includes various cabin sections, including, for example, a first cabin section 118, a second cabin section 120, a third cabin section 122, and a pilot cabin 124. In various embodiments, each of the first cabin section 118, the second cabin section 120, the third cabin section 122 includes passenger seats 130 in which passengers may be seated and each passenger seat includes an associated infotainment system with which interaction with a passenger may occur. In that regard, in various embodiments, each of the one or more infotainment system provide a user interface (UI) for the passengers to interface with a language-enabled intelligence system, so as to perform various operations, i.e., submit requests to crew members or request one or more videos, request operations associated with their seat, i.e. light on/off, air on/off, or seat recline/straighten, among others, in real-time to provide automatic predictive crew service triggers. In various embodiments, aircraft 100 may include at least a front galley zone 126 and/or a rear galley zone 128.

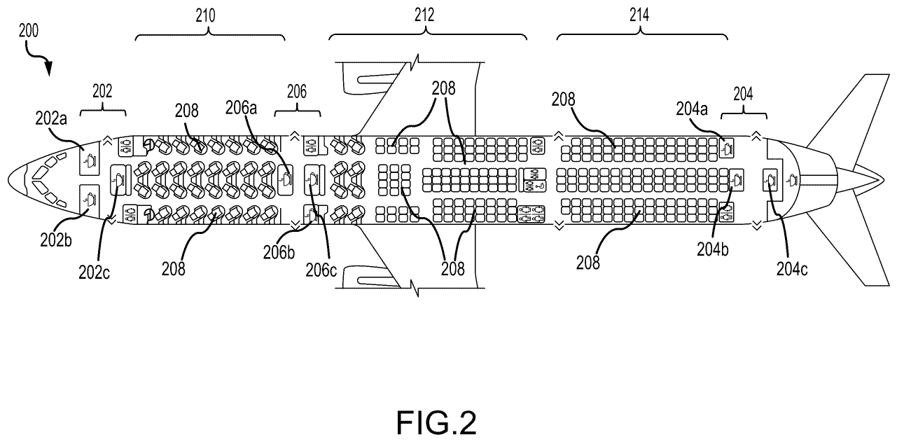

Referring now to FIG. 2, a layout of a typical larger-bodied passenger aircraft, is illustrated, in accordance with various embodiments. In various embodiments, the aircraft 200 includes passenger seats 208 in passenger seat sections 210, 212, and 214. In various embodiments, each of the passenger seats 208 in the aircraft 200 may include an associated infotainment system with which interaction by the associated passenger may occur. In that regard, in various embodiments, each of the one or more infotainment systems provide a user interface (UI) for the passengers to interface with a language-enabled intelligence system, so as to perform various requests, i.e., adaptively accesses conversation memory, submit requests to the crew member, and/or requests access to an entertainment feature, among others in order to have a personalized in-flight experience.

Additionally, in various embodiments, aircraft 200 (such as aircraft 100 of FIG. 1) includes three galley zones, a front galley zone 202 (such as front galley zone 126 of FIG. 1), a rear galley zone 204 (such as rear galley zone 128 of FIG. 1), and intermediate galley zone 206. In various embodiments, each of the front galley zone 202, the rear galley zone 204, and the intermediate galley zone 206 may have one or more galleys, i.e., galley 202a, 202b, and 202c associated with the front galley zone 202, galley 204a, 204b, and 204c associated with the rear galley zone 204, galley 206a, 206b, and 206c associated with the intermediate galley zone 206. In various embodiments, each of the galleys 202a, 202b, 202c, 204a, 204b, 204c, 206a, 206b, and 206c in the aircraft 200 may include one or more digital panels with which interaction may occur. In that regard, in various embodiments, each of the one or more digital panels provide a user interface (UI) for the crew members to interface with a language-enabled intelligence system, so as to perform various operations, i.e., receive and fulfill requests from passengers, adaptively accesses conversation memory, track inventory states, and/or monitor crew activity, among others, in real-time to provide automatic predictive crew service triggers and manage interior functions with high assurance.

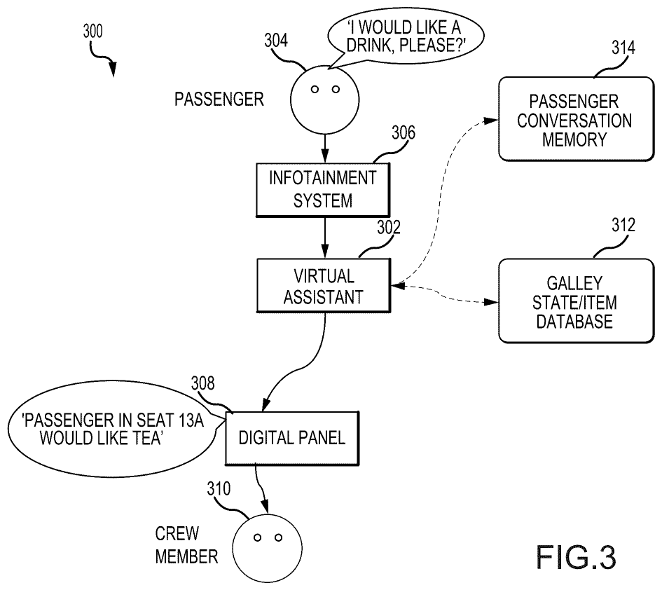

Referring now to FIG. 3, a multilingual in-flight planning system for personalized passenger experience is illustrated, in accordance with various embodiments. In various embodiments, the multilingual in-flight planning system 300 utilizes a multilingual language-enabled virtual assistant 302, which may be accessed via an infotainment system 306 associated with a passenger seat of a passenger 304, such as one of passenger seats 208 of FIG. 2 or one or more digital panels 308 associated with galleys 202a, 202b, 202c, 204a, 204b, 204c, 206a, 206b, and 206c of FIG. 2, associated with a crew member 310, among others. In various embodiments, the multilingual language-enabled virtual assistant 302 is configured to converse and/or interact with the passenger 304 and/or the crew member 310 in a respective native language of the passenger 304 and/or the crew member 310 via the infotainment system 306 or the one or more digital panels 308, respectively. Accordingly, in various embodiments, multilingual language-enabled virtual assistant 302 utilizes a seamless natural language interface based on a domain-grounded and large language model (LLM) intelligence agent configured with an artificial intelligence (AI) model, machine learning (ML) model, deep learning model, neural network, convolutional neural network, computer vision algorithm, object detection algorithm, object recognition algorithm, classification algorithm, regression algorithm, or other computational model configured to allow passengers and/or crew members to converse with multilingual language-enabled virtual assistant 302 in various areas within the interior of the aircraft, such as the infotainment system 306 or the one or more digital panels 308.

In various embodiments, the multilingual language-enabled virtual assistant 302 adaptively accesses conversation memory and/or inventory states, among others, in real time to provide response to the requesting passenger and or to generate automatic crew service triggers. Therefore, in various embodiments, the multilingual language-enabled virtual assistant 302 is a multilingual natural language interface configured to identify intent and/or context, among others, of a passenger 304 or a crew member 310 and provide high-level planning for the passenger 304 and crew member action execution for the crew member 310. In that regard, in various embodiments, the multilingual language-enabled virtual assistant 302, and which may be touch or voice enabled, is configured to interact in a natural language of the passenger 304 to assist the passenger 304 in planning and/or configuring a personalized in-flight experience. In various embodiments, the multilingual language-enabled virtual assistant 302 may be partially embedded in the infotainment system 306 and/or one or more digital panels 308. In various embodiments, the multilingual language-enabled virtual assistant 302 may be remote from but accessible via the infotainment system 306 and the one or more digital panels 308. In that regard, in various embodiments, the multilingual language-enabled virtual assistant 302 may interact through a speaker or screen associated with the infotainment system 306 and/or the one or more digital panels 308.

In various embodiments, the multilingual language-enabled virtual assistant 302 may be configured to interact with the galley/interior state/item database 312 and/or the passenger conversation memory 314, among others, to generate an appropriate response to the passenger 304 and/or crew member 310, via the infotainment system 306 and/or the one or more digital panels 308. Accordingly, in various embodiments, the infotainment system 306 and the one or more digital panels 308 include a user interface (UI) that includes an automatic speech recognition (ASR) mechanism configured to interpret words spoken by the crew member 310 and/or the passenger 304 and generate a text form of the interpreted words as well as a text to speech (TTS) mechanism configured to generate voice narrations using the data from the generated response in the UI and/or display the information on a display of the UI.

In various embodiments, the ASR mechanism may employ acoustic models, language models, pronunciation dictionaries, or neural network-based speech recognition techniques including, but not limited to, recurrent neural networks (RNNs), long short-term memory (LSTM) networks, convolutional neural networks (CNNs), or transformer architectures, to convert audio input into text. In various embodiments, the multilingual language-enabled virtual assistant 302 comprises dedicated input/output interfaces configured to receive information from the UI of the infotainment system 306 and/or the one or more digital panels 308. In various embodiments, the multilingual language-enabled virtual assistant 302 may further comprise internal memory to store data, executable instructions, system program instructions, and/or controller instructions to implement the control logic of the multilingual language-enabled virtual assistant 302. In various embodiments, the memory comprises volatile memory, such as random access memory (RAM) including static RAM (SRAM) or dynamic RAM (DRAM), and non-volatile memory, such as semiconductor-based storage devices including flash memory (e.g., NAND flash, NOR flash, or eMMC), electrically erasable programmable read-only memory (EEPROM), or solid-state storage (e.g., solid-state drives (SSDs), NVMe storage, or embedded multimedia cards), magnetic-based storage devices including hard disk drives (HDDs) or magnetic tape, or optical-based storage devices including compact discs (CDs), digital versatile discs (DVDs), or Blu-ray discs. In various embodiments, multilingual language-enabled virtual assistant 302 may comprise one or more processing units including, but not limited to, microprocessors, microcontrollers, digital signal processors (DSPs), field-programmable gate arrays (FPGAs), application-specific integrated circuits (ASICs), graphics processing units (GPUs), tensor processing units (TPUs), or combinations thereof.

In various embodiments, the multilingual language-enabled virtual assistant 302 may support a plurality of languages including, but not limited to, from about 2 languages to about 200 languages, from about 10 languages to about 150 languages, or from about 20 languages to about 100 languages. In various embodiments, the multilingual language-enabled virtual assistant 302 may achieve language translation accuracy of from about 70% to about 99.9%, from about 85% to about 99%, or from about 90% to about 98%. In various embodiments, the multilingual language-enabled virtual assistant 302 may process speech input at a rate of from about 50 words per minute to about 300 words per minute (from about 0.83 words per second to about 5 words per second), from about 100 words per minute to about 250 words per minute (from about 1.67 words per second to about 4.17 words per second), or from about 120 words per minute to about 200 words per minute (from about 2 words per second to about 3.33 words per second).

In various embodiments, the multilingual language-enabled virtual assistant 302 is configured to determine the native language of the passenger 304 and/or the crew member 310 through one or more language identification mechanisms including, but not limited to, passenger profile data associated with reservation or booking information, language selection received via the infotainment system 306 or one or more digital panels 308, automatic language detection based on initial spoken or typed input, or inference from geographic origin or flight route information. In various embodiments, the multilingual language-enabled virtual assistant 302 may employ language identification models including, but not limited to, neural network-based classifiers, n-gram analysis, acoustic feature analysis for spoken language identification, or character-level pattern recognition for written text, to automatically identify and adapt to the preferred language of the passenger 304 and/or the crew member 310.

System program instructions and/or controller instructions may be loaded onto a non-transitory, tangible computer-readable medium having instructions stored thereon that, in response to execution by the multilingual language-enabled virtual assistant 302, cause the multilingual language-enabled virtual assistant 302 to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

In various embodiments, the multilingual language-enabled virtual assistant 302 is configured to utilize one or more fusion modules, data integration techniques, or aggregation methods to classify and filter the interpreted words based on at least one of context and intent, i.e., a question or statement, among others, derived from the set of interpreted words as well as additional context, such as current live status of items or interior features from the galley/interior state/item database 312 and/or the passenger conversation memory 314, among others, as will be described hereafter in detail, to generate an appropriate response to the crew member 310, via the one or more digital panels 308, and/or the passenger 304, via the infotainment system 306. In various embodiments, multilingual language-enabled virtual assistant 302 may implement transformer-based architectures, attention mechanisms, encoder-decoder structures, or other neural network configurations suitable for multilingual natural language understanding and generation. In various embodiments, the multilingual language-enabled virtual assistant 302 is configured to respond to the crew member 310 and/or passenger 304 via the TTS mechanism that generates voice narrations using the data from the generated response in the UI of the one or more digital panels 308 and/or the infotainment system 306, respectively, and/or display the information on a display of the UI of the one or more digital panels 308 and/or the infotainment system 306, respectively.

In various embodiments, the multilingual language-enabled virtual assistant 302 may achieve response latency times of from about 50 milliseconds to about 5000 milliseconds (from about 0.05 seconds to about 5 seconds), from about 100 milliseconds to about 2000 milliseconds (from about 0.1 seconds to about 2 seconds), or from about 200 milliseconds to about 1000 milliseconds (from about 0.2 seconds to about 1 second). In various embodiments, the multilingual language-enabled virtual assistant 302 may operate with a memory capacity of from about 1 gigabyte (GB) to about 1 terabyte (TB) (from about 1.07 billion bytes to about 1.1 trillion bytes), from about 4 GB to about 256 GB (from about 4.29 billion bytes to about 274.9 billion bytes), or from about 8 GB to about 64 GB (from about 8.59 billion bytes to about 68.7 billion bytes).

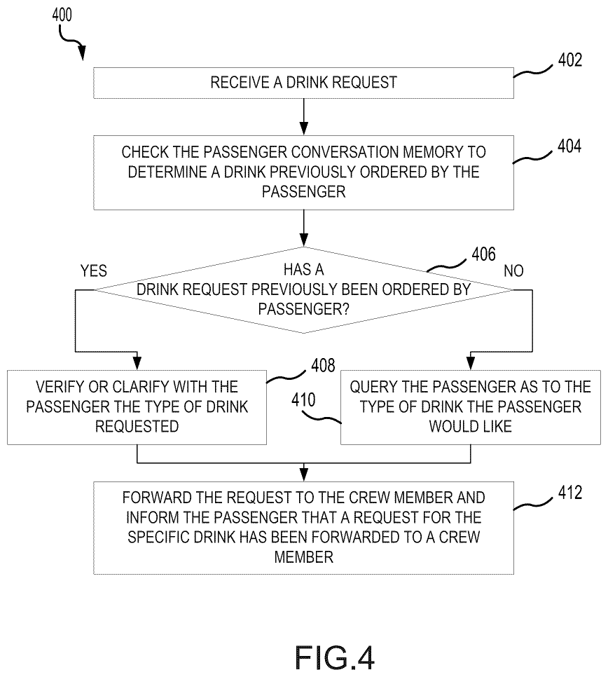

With additional reference to FIG. 4, a flow diagram 400 of a multilingual in-flight planning system for personalized passenger experience receiving a drink request from a passenger is illustrated, in accordance with various embodiments. In that regard, in various embodiments, at block 402, a drink request is received from the passenger 304, and at block 404, the multilingual language-enabled virtual assistant 302 may check the passenger conversation memory 314 to determine whether a drink has previously been ordered by the passenger 304. In various embodiments, at block 406, upon identifying a drink previously ordered by the passenger 304, at block 408, the multilingual language-enabled virtual assistant 302 may either verify or clarify with the passenger 304 the type of drink requested. In various embodiments, at block 406, if no record of a previously ordered drink is found within the passenger conversation memory 314, at block 410, the multilingual language-enabled virtual assistant 302 may query the passenger 304 as to the type of drink the passenger 304 would like, via the infotainment system 306. In various embodiments, responsive to the type of drink being verified or provided, at block 412, the multilingual language-enabled virtual assistant 302 may be configured to forward the request to the crew member 310, via the one or more digital panels 308, and inform the passenger 304, via the infotainment system 306, that a request for the specific drink has been forwarded to a crew member 310.

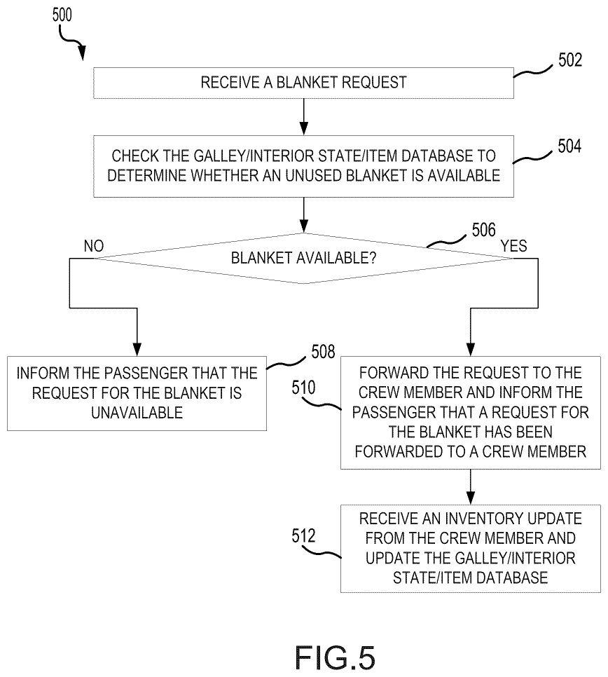

With additional reference to FIG. 5, a flow diagram 500 of a multilingual in-flight planning system for personalized passenger experience receiving a blanket request from a passenger is illustrated, in accordance with various embodiments. In various embodiments, the multilingual language-enabled virtual assistant 302 may be configured to check the galley/interior state/item database 312 to determine whether the requested item is available in the galley or interior of the aircraft. In that regard, in various embodiments, at block 502, a blanket request is received from the passenger 304, and, at block 504, the multilingual language-enabled virtual assistant 302 may be configured to check the galley/interior state/item database 312 to determine whether an unused blanket is available. In various embodiments, at block 506, if an indication of an unused blanket being unavailable is received, then, at block 508, the multilingual language-enabled virtual assistant 302 may be configured to inform the passenger 304, via the infotainment system 306, that the request for the blanket is unavailable. In various embodiments, at block 506, if an indication of an unused blanket being available is received, then, at block 510, the multilingual language-enabled virtual assistant 302 may be configured to forward the request to the crew member 310, via the one or more digital panels 308, and inform the passenger 304, via the infotainment system 306, that a request for the blanket has been forwarded to a crew member 310. In various embodiments, responsive to the request being fulfilled by the crew member 310, then, at block 512, the multilingual language-enabled virtual assistant 302 may be configured to receive an inventory update from the crew member 310, via the one or more digital panels 308, and update the galley/interior state/item database 312.

In various embodiments, once the multilingual language-enabled virtual assistant 302 has verified the request from the passenger 304, the multilingual language-enabled virtual assistant 302 may be configured to store information associated with the request in passenger conversation memory 314 and to forward the request to a crew member 310, via the one or more digital panels 308 indicating the request and the passenger 304 who originated the request by seat number, which assists the crew member 310 in orchestrating tasks seamlessly across the cabin. In various embodiments, the request may be presented to the crew member, via the one or more digital panels 308, by either presenting the request via the text to speech (TTS) mechanism via the one or more digital panels 308 or displaying the request on the display of the one or more digital panels 308.

In various embodiments, by the multilingual language-enabled virtual assistant 302 accessing the galley/interior state/item database 312 and/or the passenger conversation memory 314, the multilingual language-enabled virtual assistant 302 is configured to learn from a specific passenger's previous in-flight preferences, experiences, and interaction and customize future requests and/or suggestion for the passenger 304. In various embodiments, by the multilingual language-enabled virtual assistant 302 accessing the galley/interior state/item database 312 and/or the passenger conversation memory 314, the multilingual language-enabled virtual assistant 302 may reduce crew member workload and increase efficiency by eliminating the time associated with the crew member 310 having to navigate to the passenger's seat to identify the need of the passenger 304 and then navigate back to the galley to fulfill the passenger request thereby optimizing crew workload while maximizing passenger comfort.

In various embodiments, the multilingual language-enabled virtual assistant 302 is configured to generate automatic predictive crew service triggers based on analysis of patterns within the passenger conversation memory 314, real-time context such as flight phase, time elapsed since last service, and environmental conditions, and/or aggregated passenger behavior data. In various embodiments, the automatic predictive crew service triggers may include, but are not limited to, proactive beverage or meal service notifications, anticipated comfort item requests based on historical patterns, entertainment recommendations based on previously consumed content, and anticipated service timing based on passenger preferences stored in the passenger conversation memory 314.

In various embodiments, the communication between the multilingual language-enabled virtual assistant 302, the infotainment system 306, the one or more digital panels 308, the galley/interior state/item database 312, and the passenger conversation memory 314 may utilize any suitable protocol including, but not limited to, digital interfaces, analog interfaces, serial communication protocols, parallel communication protocols, I2C, SPI, UART, CAN bus, USB, Ethernet, optical fiber communication, power line communication, or proprietary protocols, as well as any future communication standards developed for avionics or cabin systems. In various embodiments, wireless communications may operate within any frequency bands approved for aircraft cabin use for radio frequency susceptibility and emissions, including but not limited to wireless local area network protocols (e.g., those sold under the Wi-Fi® trademark), short-range wireless protocols (e.g., those sold under the Bluetooth® trademark), low energy short-range wireless protocols (e.g., those sold under the Bluetooth Low Energy trademark), mesh network protocols (e.g., those sold under the Zigbee® or Z-Wave® trademarks), IEEE 802.15.4, IEEE 802.11 variants, 5G, cellular communication protocols, satellite communication protocols, ultra-wideband (UWB), or other existing or future wireless standards, thereby ensuring no or reduced interference with aircraft avionics, navigation systems, and/or communication equipment.

Accordingly, the multilingual in-flight planning system 300 may be configured to provide a premium-level in-flight experience (e.g., in-flight entertainment, food and beverage preference and schedule, optimal schedule to take rest, or layover plan, among others) that is exciting, seamless, and robust. The multilingual in-flight planning system 300 may be configured to improve on-time response to passengers, reduce crew workload and increase efficiency, and better allocate resources and crew allocation across the cabin of an aircraft.

Benefits and other advantages have been described herein with regard to specific embodiments. Furthermore, the connecting lines shown in the various figures contained herein are intended to represent exemplary functional relationships and/or physical couplings between the various elements. It should be noted that many other or additional functional relationships or physical connections may be present in a practical system. However, the benefits, advantages, and any elements that may cause any benefit or advantage to occur or become more pronounced are not to be construed as indispensable features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, it is submitted that a particular feature, structure, or characteristic described in connection with an embodiment is within the knowledge of one skilled in the art to affect such feature, structure, or characteristic in connection with other embodiments whether or not explicitly described. After reading the description, it will be apparent to one skilled in the relevant art(s) how to implement the disclosure in other embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 10%, within 5%, within 1%, within 0.1%, or within 0.01% of a stated value. Additionally, the terms “substantially,” “about,” or “approximately” as used herein represent an amount close to the stated amount that still performs a desired function or achieves a desired result. For example, the term “substantially,” “about,” or “approximately” may refer to an amount that is within 10% of, within 5% of, within 1% of, within 0.1% of, and within 0.01% of a stated amount or value.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A multilingual in-flight planning system for aircraft interiors, comprising:
a first user interface configured to receive and transmit first information to or from a passenger in a native language of the passenger;
a second user interface configured to receive and transmit second information to or from at least one crew member; and
a multilingual language-enabled virtual assistant, the multilingual language-enabled virtual assistant communicatively coupled to the first user interface and the second user interface, wherein the multilingual language-enabled virtual assistant is configured to:
receive a request from at least one of the first user interface or the second user interface;
analyze the request based on at least one of context or intent; and
generate a response to the request, wherein the response is transmitted to either a user interface of the at least one of the first user interface or the second user interface that generated the request or an opposite one of the at least one of the first user interface or the second user interface that generated the request.

2. The multilingual in-flight planning system of claim 1, wherein, responsive to receiving the request from the passenger via the first user interface, the multilingual language-enabled virtual assistant is further configured to:
reference a passenger conversation memory to determine whether a previous request has been received from the passenger; and
responsive to identifying the previous request from the passenger, query the passenger for at least one of a verification or a clarification of the request with the passenger via the first user interface, wherein the at least one of the verification or the clarification of the request is presented to the passenger via text to speech via the first user interface or displayed in a display of the first user interface.

3. The multilingual in-flight planning system of claim 2, wherein, responsive to verifying or clarifying the request with the passenger via the first user interface, the multilingual language-enabled virtual assistant is further configured to:
transmit the request to the at least one crew member associated with the second user interface, wherein the request is presented to the at least one crew member via text to speech via the second user interface or displayed in a display of the second user interface.

4. The multilingual in-flight planning system of claim 3, wherein, responsive to transmitting the request to the at least one crew member associated with the second user interface, the multilingual language-enabled virtual assistant is further configured to:
send a notification to the passenger, via the first user interface, that the request has been forwarded to the at least one crew member.

5. The multilingual in-flight planning system of claim 1, wherein, responsive to receiving the request from the passenger via the first user interface, the multilingual language-enabled virtual assistant is further configured to:
reference a galley/interior state/item database to determine whether an item associated with the request is available; and
responsive to identifying the item associated with the request being unavailable, send a first notification to the passenger, via the first user interface that the item associated with the request is unavailable, wherein the first notification is presented to the passenger via text to speech via the first user interface or displayed in a display of the first user interface.

6. The multilingual in-flight planning system of claim 5, wherein responsive to identifying the item associated with the request is available, the multilingual language-enabled virtual assistant is further configured to:
transmit the request to the at least one crew member associated with the second user interface, wherein the request is presented to the at least one crew member via text to speech via the second user interface or displayed in a display of the second user interface.

7. The multilingual in-flight planning system of claim 6, wherein, responsive to transmitting the request to the at least one crew member associated with the second user interface, the multilingual language-enabled virtual assistant is further configured to:
send a second notification to the passenger, via the first user interface, that the request has been forwarded to the at least one crew member.

8. The multilingual in-flight planning system of claim 1, wherein the first user interface is configured to receive the request from the passenger via automatic speech recognition (ASR) configured to interpret the information received via the first user interface and generate a set of interpreted words in text form, the set of interpreted words in text form utilized to generate the request.

9. The multilingual in-flight planning system of claim 1, wherein the first user interface is an infotainment system associated with a passenger seat of an aircraft.

10. The multilingual in-flight planning system of claim 1, wherein the second user interface is a digital panel associated with a galley on an aircraft.

11. An aircraft comprising:
a passenger seat;
an infotainment system associated with the passenger seat;
a galley;
a digital panel associated with the galley; and
a multilingual in-flight planning system coupled to at least one infotainment system or the digital panel, the multilingual in-flight planning system comprising:
a first user interface configured to receive and transmit first information to or from a passenger in a native language of the passenger;
a second user interface configured to receive and transmit second information to or from at least one crew member; and
a multilingual language-enabled virtual assistant, the multilingual language-enabled virtual assistant communicatively coupled to the first user interface and the second user interface, wherein the multilingual language-enabled virtual assistant is configured to:
receive a request from at least one of the first user interface or the second user interface;
analyze the request based on at least one of context or intent; and
generate a response to the request, wherein the response is transmitted to either a user interface of the at least one of the first user interface or the second user interface that generated the request or an opposite one of the at least one of the first user interface or the second user interface that generated the request.

12. The aircraft of claim 11, wherein, responsive to receiving the request from the passenger via the first user interface, the multilingual language-enabled virtual assistant is further configured to:
reference a passenger conversation memory to determine whether a previous request has been received from the passenger; and
responsive to identifying the previous request from the passenger, query the passenger for at least one of a verification or a clarification of the request with the passenger via the first user interface, wherein the at least one of the verification or the clarification of the request is presented to the passenger via text to speech via the first user interface or displayed in a display of the first user interface.

13. The aircraft of claim 12, wherein, responsive to verifying or clarifying the request with the passenger via the first user interface, the multilingual language-enabled virtual assistant is further configured to:
transmit the request to the at least one crew member associated with the second user interface, wherein the request is presented to the at least one crew member via text to speech via the second user interface or displayed in a display of the second user interface.

14. The aircraft of claim 13, wherein, responsive to transmitting the request to the at least one crew member associated with the second user interface, the multilingual language-enabled virtual assistant is further configured to:
send a notification to the passenger, via the first user interface, that the request has been forwarded to the at least one crew member.

15. The aircraft of claim 11, wherein, responsive to receiving the request from the passenger via the first user interface, the multilingual language-enabled virtual assistant is further configured to:
reference a galley/interior state/item database to determine whether an item associated with the request is available; and
responsive to identifying the item associated with the request being unavailable, send a first notification to the passenger, via the first user interface that the item associated with the request is unavailable, wherein the first notification is presented to the passenger via text to speech via the first user interface or displayed in a display of the first user interface.

16. The aircraft of claim 15, wherein responsive to identifying the item associated with the request is available, the multilingual language-enabled virtual assistant is further configured to:
transmit the request to the at least one crew member associated with the second user interface, wherein the request is presented to the at least one crew member via text to speech via the second user interface or displayed in a display of the second user interface.

17. The aircraft of claim 16, wherein, responsive to transmitting the request to the at least one crew member associated with the second user interface, the multilingual language-enabled virtual assistant is further configured to:
send a second notification to the passenger, via the first user interface, that the request has been forwarded to the at least one crew member.

18. The aircraft of claim 11, wherein the first user interface is configured to receive the request from the passenger via automatic speech recognition (ASR) configured to interpret the information received via the first user interface and generate a set of interpreted words in text form, the set of interpreted words in text form utilized to generate the request.

19. The aircraft of claim 11, wherein the first user interface is the infotainment system associated with the passenger seat of the aircraft.

20. The aircraft of claim 11, wherein the second user interface is the digital panel located in the galley on the aircraft.
